(19) United States
(12) Patent Application Publication
(10) Pub. No.: US 2025/0028529 A1
(43) Pub. Date: Jan. 23, 2025

(54) COMPUTATIONAL WORKFLOW ENGINE FOR SEQUENTIAL AND PARALLEL PROCESSING

(71) Applicant: FMR LLC, Boston, MA (US)

(72) Inventors: Babuvenkatesh Jeyapal, Chennai (IN); Hema Priya Elumalai Palani, Chennai (IN); Shyam Sreekumar Nair, Bangalore (IN); Daman Dogra, Westford, MA (US); Biju Kozhikode Kizhakhemadtil, Hingham, MA (US)

(21) Appl. No.: 18/765,574

(22) Filed: Jul. 8, 2024

Related U.S. Application Data
(60) Provisional application No. 63/527,621, filed on Jul. 19, 2023.

(51) Int. Cl. G06F 9/28

(52) U.S. Cl. CPC G06F 9/28

(57) ABSTRACT

A method for processing a software application workflow using a workflow engine includes receiving a workflow configuration defining the workflow including a plurality of nodes and a plurality of connections between the nodes, each of the nodes associated with a corresponding software processing task. The method includes determining a first set of nodes of the plurality of nodes to be executed based on the workflow configuration and the plurality of connections. The method includes causing execution of the software processing tasks associated with the first set of nodes, resulting in an execution result. The method includes determining a second set of nodes of the plurality of nodes to be executed based on the workflow configuration, the plurality of connections, and the execution result. The method includes causing execution in parallel of the tasks associated with the second set of nodes.

### RELATED APPLICATIONS

This application claims priority to U.S. Patent Application No. 63/527,621, filed Jul. 19, 2023, the entirety of which is incorporated herein by reference.

### TECHNICAL FIELD

This application relates generally to computerized methods and systems, including computational workflow engines, and more specifically to a computational workflow engine that is configured to perform both sequential and parallel processing.

### BACKGROUND

Workflow engines are software applications that manage business processes. A workflow engine manages and monitors the state of software processing tasks in a workflow, such as the opening of a financial account, and determines which new task to transition to according to defined processes. The tasks may be anything from saving an application form in a document management system to sending a reminder e-mail to users or escalating overdue items to management. A workflow engine therefore facilitates the flow of information, tasks, and events.

However, existing workflow engines are limited to processing such software application tasks sequentially, i.e., one after another. In other words, the execution of a task must wait until execution of the previous task has completed. This built-in wait time leads to higher execution times for the entire workflow and an unnecessary delay in generating the results of the workflow. In particularly complex software application workflows, the delay can amount to a significant slowdown in computing performance and transaction execution. Also, traditional computational workflow engines do not break or skip the flow of functionalities dynamically, nor do they have any ways to reuse the same workflow with multiple processes.

### SUMMARY

Therefore, what is needed are computerized methods and systems, including improved computational workflow engines, that enable both sequential and parallel processing of application tasks. The techniques described herein advantageously provides for dynamic and flexible configuration of software processing task execution by using graph-based data structures along with specifically designed algorithms for traversing the graph and identifying tasks for execution. In addition, the methods and systems described herein beneficially provide for the dynamic reuse of a common workflow for multiple different processes using circuit breaker and short circuit techniques—where a workflow can be ended prior to completion during a given process (circuit breaker) or certain nodes in a graph data structure can be skipped during a given process (short circuit). In either case, fewer than all nodes in the graph are used but the computational workflow graph does not need to be modified.

As can be appreciated, the approach described herein enables greater processing efficiency and lower maintenance through reuse of common workflow graphs for a plurality of different computational processes. In one example system, there are 22 types of updates related to Customer & Account records that are being processed. Each of these updates have processing logic involving four to nine steps and error/exception handling at each step of the process. The techniques described herein can determine the specific processing pathway among 88-198 pathways in a workflow graph to complete the update process depending on the type of update requested. With the number of input parameters and validations to be handled within the use-case set to grow extensively with the addition of at least 10% increase of new types of updates to be supported, the systems and methods described herein can scale exponentially irrespective of changes in the underlying business logic.

The invention, in one aspect, features a computer-implemented method of processing a software application workflow. A workflow engine of a computing device receives a workflow configuration defining the software application workflow including a plurality of nodes and a plurality of connections between the nodes, each of the plurality of nodes being associated with a corresponding software processing task, the workflow configuration further including a parallel flag for each of the plurality of nodes. The workflow engine determines a first set of nodes of the plurality of nodes to be executed based on the workflow configuration and the plurality of connections. The computing device executes the software processing tasks associated with the first set of nodes to generate an execution result comprising output from the software processing tasks associated with the first set of nodes. The workflow engine determines a second set of nodes of the plurality of nodes to be executed based on the workflow configuration, the plurality of connections, and the execution result. The computing device executes in parallel the software processing tasks associated with the second set of nodes.

The invention, in another aspect, features a system for processing a software application workflow. The system includes a computing device having a memory for storing computer-executable instructions and a processor that executes the computer-executable instructions. A workflow engine of the computing device receives a workflow configuration defining the software application workflow including a plurality of nodes and a plurality of connections between the nodes, each of the plurality of nodes being associated with a corresponding software processing task, the workflow configuration further including a parallel flag for each of the plurality of nodes. The workflow engine determines a first set of nodes of the plurality of nodes to be executed based on the workflow configuration and the plurality of connections. The computing device executes the software processing tasks associated with the first set of nodes to generate an execution result comprising output from the software processing tasks associated with the first set of nodes. The workflow engine determines a second set of nodes of the plurality of nodes to be executed based on the workflow configuration, the plurality of connections, and the execution result. The computing device executes in parallel the software processing tasks associated with the second set of nodes.

Any of the above aspects can include one or more of the following features. In some embodiments, the workflow engine determines the first set of nodes using Kahn's algorithm. In some embodiments, the workflow engine determines the second set of nodes using a breadth-first search. In some embodiments, the breadth-first search identifies one or more nodes adjacent to the first set of nodes using the connections and assigns the adjacent nodes as the second set of nodes.

In some embodiments, determining the second set of nodes results in skipping one or more of the plurality of nodes in the workflow such that the software processing tasks associated with the skipped nodes are not executed by the computing device. In some embodiments, determining the second set of nodes results in ending the workflow such that no further software processing tasks associated with the workflow are executed by the computing device. In some embodiments, the computing device executes in parallel only the software processing tasks associated with nodes in the second set of nodes that have a parallel flag set to active. In some embodiments, the computing device sequentially executes the software processing tasks associated with nodes in the second set of nodes that have a parallel flag set to inactive. In some embodiments, the workflow configuration comprises a Directed Acrylic Graph (DAG) data structure.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is an illustration of a system for executing a computational workflow engine in accordance with an embodiment of the present invention.

FIG. 2 is a flowchart of a method for processing a workflow using a workflow engine in accordance with an embodiment of the present invention.

FIG. 3 is flowchart of an exemplary parallel workflow.

FIG. 4 is a flowchart of an exemplary sequential workflow.

FIG. 5 is an exemplary configuration of a workflow node and its connections in accordance with an embodiment of the present invention.

FIG. 6 is an exemplary directed acyclic graph as defined by a workflow configuration.

FIG. 7 is an exemplary directed acyclic graph as defined by a workflow configuration.

### DETAILED DESCRIPTION

As used in this description and the accompanying claims, the following terms shall have the meanings indicated, unless the context otherwise requires:
A “set” includes at least one member.

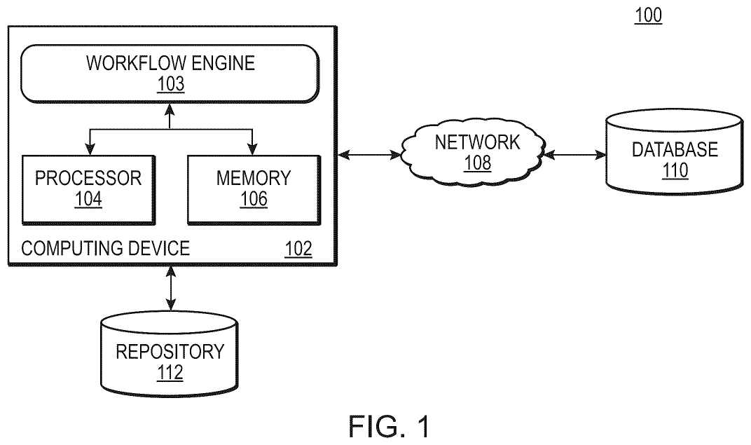

FIG. 1 is an illustration of a system 100 for processing a workflow in accordance with an embodiment of the present invention. System 100 includes computing device 102 with workflow engine 103, processor 104 and memory 106. System 100 also includes communications network 108, database 110, and repository 112.

Computing device 102 includes specialized hardware and/or software modules that execute on one or more processors (e.g., processor 104) and interact with memory modules (e.g., memory 106) to receive data from other components of system 100, transmit data to other components of system 100, and enable functions of a computational workflow engine (e.g., engine 103) that is configured to perform both sequential and parallel processing as described herein. Computing device 102 includes workflow engine 103 that executes on one or more processors (e.g., processor 104) of computing device 102. In some embodiments, workflow engine 103 is a specialized set of computer software instructions programmed onto one or more dedicated processors in computing device 102 and can include specifically designated memory locations and/or registers for executing the specialized computer software instructions. It should be appreciated that any number of computing devices, arranged in a variety of architectures, resources, and configurations (e.g., cluster computing, virtual computing, cloud computing) can be used without departing from the scope of the invention.

Advantageously, processor 104 allows for parallel processing, for example by providing a plurality of cores. While a processor 104 is described herein, it is expressly contemplated that computing device 102 has a plurality of processors. In that case, each of the plurality of processors of computing device 102 is coupled to memory 106 and is configured to execute the workflow engine described herein. The plurality of processors allows for parallel processing. In addition, one or more of the plurality of processors may provide a plurality of cores to further enhance the parallel processing capabilities of computing device 102.

Communications network 104 enables computing device 102 and database 110 to communicate with each other. Network 104 is typically a wide area network, such as the Internet and/or a cellular network. In some embodiments, network 104 is comprised of several discrete networks and/or sub-networks (e.g., cellular to Internet).

Database 110 comprises transient and/or persistent memory for data storage, that is used in conjunction with the process of enabling functions of a computational workflow engine (e.g., engine 103) that is configured to perform both sequential and parallel processing as described herein. It should be appreciated that, in some embodiments, database 110 comprises a separate computing device (or in some embodiments, a plurality of separate computing devices) coupled to server computing device 106. Database 110 is configured to receive, generate, and store specific segments of data as described herein. For example, database 110 can comprise one or more relational or non-relational databases configured to store portions of data used by the other components of system 100.

Software repository 112 is a computing device (or in some embodiments, a set of computing devices) coupled to computing device 102. Repository 112 is configured to receive, generate, store, and make available specific segments of data relating to the process of enabling functions of a computational workflow engine (e.g., engine 103) that is configured to perform both sequential and parallel processing as described herein. In some embodiments, repository 112 may be communicatively coupled to computing device 102, or it may be a part of computing device 102. In other embodiments, repository 112 may be accessed by computing device 102 over network 108. Repository 112 allows the computer system 102 to store and retrieve workflow configurations and executables for tasks (e.g., software artifacts, processes, code, files, etc.) associated with the workflow.

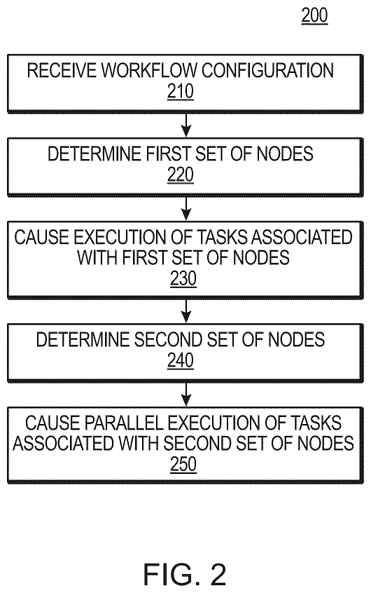

FIG. 2 is a flowchart of a computer-implemented method 200 for processing a workflow in accordance with an embodiment of the present invention, using system 100 of FIG. 1. Specifically, method 200 may be carried out by workflow engine 103 that is executed by processor 104 of computer system 102 as described above with reference to FIG. 1.

In step 210, workflow engine 103 receives a workflow configuration that defines the software application workflow. The software application workflow includes a plurality of nodes and a plurality of connections between the nodes. Each of the plurality of nodes is associated with a corresponding software processing task. The workflow configuration further includes a parallel flag for each of the plurality of nodes. Workflow engine 103 may receive the workflow configuration from a software repository such as repository 112 or from a database such as database 110. Workflow engine 103 may also receive the workflow configuration from any other source inside computer system 102 and/or connected to the network 108, as known to the skilled person. In some embodiments, workflow engine 103 may validate the received workflow configuration. The validation may be performed once after the workflow has been received, it may be performed after each update of the workflow, and/or it may be performed for a certain node before the execution of the task associated with that node. The validation may, for example, ensure that the input data for a node is present and of the correct type, that the task associated with the node is available and functional, that the configuration data for the workflow leads to a proper directional acyclic graph (DAG), and/or any other property known to the skilled person.

It is also expressly noted that workflow engine 103 may cache the received workflow configuration, for example in memory 106 or in a file system coupled to computer system 102. The caching of the configuration ensures that the workflow configuration does not change while the software application workflow is processed and therefore allows for external updating of the configuration even while a software application workflow using the configuration is running. In case of a cached configuration, workflow engine 103 may occasionally refresh the cached configuration. The refresh may be triggered in any way known to the skilled person, such as manually, at certain timepoints, and/or by other programs or data available to workflow engine 103. The cache refresh allows workflow engine 103 to load and execute an updated software application workflow having an updated set of instructions without any downtime. It is further expressly contemplated that the workflow configuration may be updated by the software application workflow itself, for example by a software processing task associated with a node in the software application workflow.

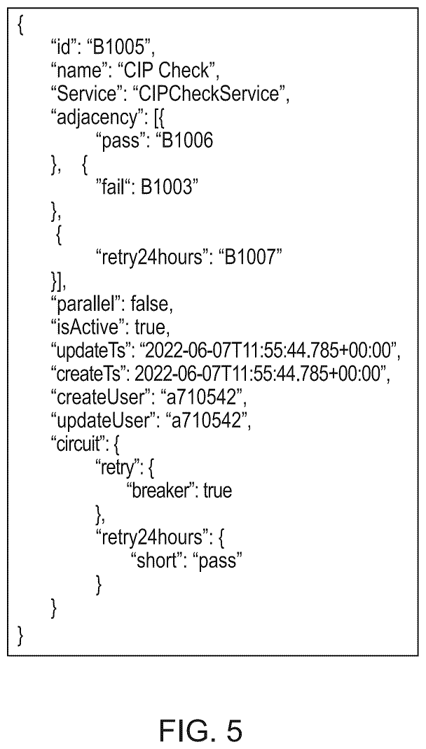

FIG. 5 shows an exemplary configuration 500 of a workflow node and its connections in accordance with an embodiment of the present invention. As can be seen, the workflow configuration of the node having the ID B1005 defines certain properties and parameters of the node itself and of its connections to other nodes. Illustratively, node B1005 is named “CIP Check” and is associated with a corresponding task “CIPCheckService.” The task field defines which executable program or service that computing device 102 executes for this node. Computing device 102 may retrieve the executable program and/or service from its file system, from memory 106, from repository 112, from database 110, or from any other source known to the skilled person. It is also expressly noted that the executable program may be a set of programs. For example, the task may be a batch file that calls a set of executable programs, or it may be another workflow to be executed by workflow engine 103 or by a different workflow engine (e.g., executed by computing device 102 or by another computing device coupled to network 108 (not shown)). This allows for simple plug-and-play of already existing software application workflows or and/or processes into the workflow engine described herein. The workflow configuration may also define an input, and optionally the data type of the input, for the executable program or service. The input may be of any data type and may be retrieved from any source known to the skilled person, such as the output of another node or other nodes in the software application workflow, database 110, repository 112, memory 106, network 108, or the file system of computing device 102.

In the case of node B1005, workflow engine 103 causes execution of a program called “CIPCheckService” by computing device 102. The execution of that program generates an execution result that workflow engine 103 may then use to determine the next node to execute. The execution result may be any output of the program that is executed, as known to the skilled person. For example, the execution result may be an exit code returned by the program, or it may be any other code stored in memory 106, in a file system coupled to computing device 102, and/or in database 110. The execution result may indicate a successful execution (pass) or a failed execution (fail). Any number of possible execution results may be configured in the workflow engine in addition to or instead of pass and fail. For example, the workflow engine may consider an exit code of 0 as pass and any other exit code as fail. In another example, the workflow engine may consider an exit code of 0 as pass, an exit code of 1 as retry, and any other exit code as fail. In other embodiments, the execution result may not be determined by exit codes but instead by values generated by the executed task and stored, for example, in database 110. It is also expressly contemplated that the workflow engine may not rely on any execution result at all, but instead may always execute a certain node as the next node.

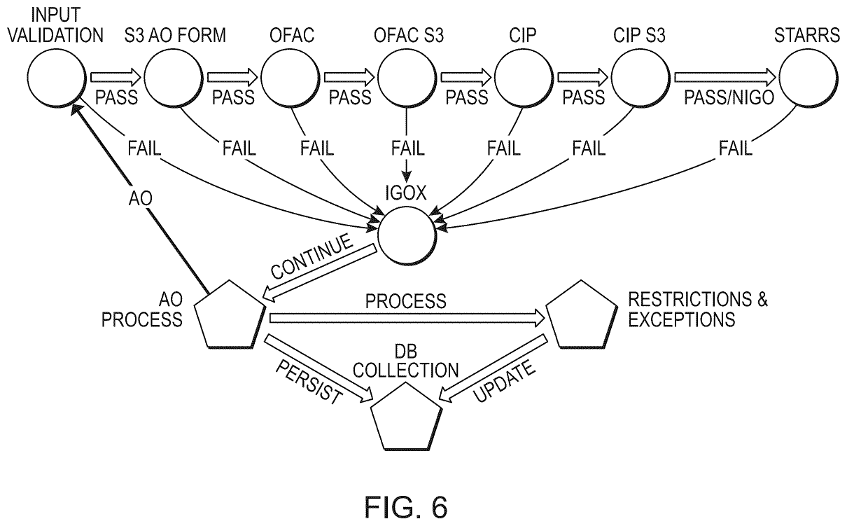

The adjacency field defines the connections of node B1005 to other nodes in the workflow. In this example, node B1005 is connected to nodes B1006, B1003, and B1007. The configuration directs workflow engine 103 to execute node B1006 next if the execution result for node B1005 indicates a pass and to execute node B1003 next if the execution result for node B1005 indicates a fail. The configuration also directs workflow engine 103 to execute node B1007 after twenty-four hours if the execution result for node B1005 indicates neither a pass nor a fail but indicates that the software processing task has to be retried. The nodes and the corresponding connections between nodes, as defined in the configuration, therefore constitute a directed acyclic graph. FIG. 6 shows an example of such a DAG as defined by a workflow configuration. The example shown in FIG. 6 defines a sequential software application workflow from the top left node to the top right node in case all software processing tasks result in an execution result of pass. If any of the software processing task executions fail, workflow engine 103 does not execute the next node in the top row, but instead causes execution of the node labeled IGOX.

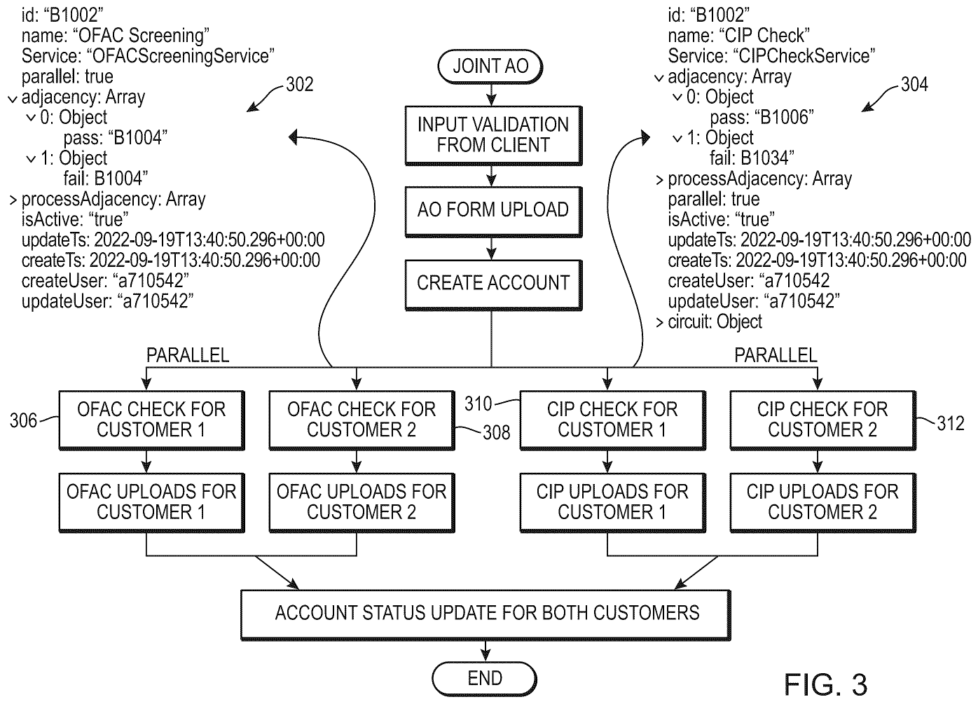

Workflow configuration 500 further includes a parallel flag. This flag determines whether the tasks associated with node B1005 may be executed in parallel with the tasks of other nodes. While the flag is set to false (i.e., inactive) for the exemplary node B1005, FIG. 3, as described in detail further below, includes illustrative nodes having their parallel flags set to true (i.e., active). Workflow configuration 500 also includes a circuit breaker flag and a short-circuit flag. The circuit breaker flag informs the workflow engine to stop processing the workflow once the task associated with the respective node has been executed by computing device 102. Here, workflow engine 103 would stop processing the workflow if the task associated with node B1005 needs to be retried in twenty-four hours. The circuit breaker flag thus prevents the workflow from progressing if node B1005 has not been executed successfully and has not generated a result. The short-circuit flag, on the other hand, instructs workflow engine 103 to skip a certain node. In this example, workflow engine 103 is instructed to skip node B1007 (as defined in the 24-hour retry adjacency) if the execution result of the software processing task associated with node B1005 indicates a success. The short-circuit flag thus prevents an unnecessary repeat execution of a software processing task that has already been completed successfully.

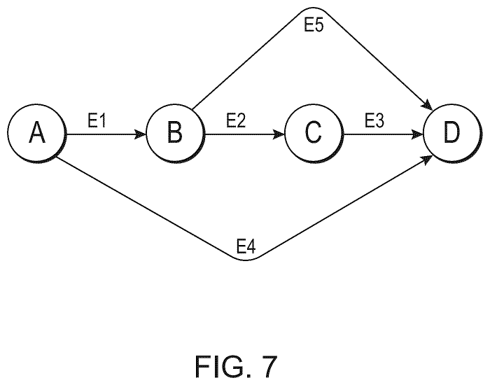

FIG. 7 shows another example of a DAG as defined by a corresponding workflow configuration. The sequential workflow proceeds from node A to node B to node C to node D, as indicated by edges E1, E2, and E3. However, this graph also includes a short circuit edge E4 from node A to node D and a short circuit edge E5 from node B to node D. These edges are defined by a short-circuit flag in the workflow configuration that underlies this graph.

In step 220, workflow engine 103 determines a second set of nodes of the first plurality of nodes to be executed based on the workflow configuration and the plurality of connections. The second set of nodes includes the start node/nodes for the workflow. The second set of nodes may include a single node, or it may include a plurality of nodes. The second set of nodes may be determined by any method known to the skilled person based on the DAG defined by the workflow configuration. For example, the second set of nodes may be determined by using Kahn's algorithm, which is an algorithm for topological sorting of a DAG using a breadth-first search. Topological sorting is a linear ordering of the nodes of the DAG such that for every directed edge uv from node u to node v, u comes before v in the resulting ordering. The adjacencies of the nodes in the workflow are defined based on the execution result of the software processing tasks associated with their corresponding nodes, i.e., the adjacencies represent constraints that a certain software processing task must be performed before another. The topological ordering then generates a valid sequence for the tasks in the software application workflow. This sequence includes one or more nodes whose tasks may be executed first. The node or nodes whose tasks are executed first constitute the first set of nodes. However, it is expressly noted that the first set of nodes may also be determined by any other method. For example, the first set of nodes may be explicitly defined in the workflow configuration, or it may be given to workflow engine 103 as an input by a user of the software application workflow.

Kahn's algorithm works by employing a breadth-first search for choosing nodes in the same order as the eventual topological sort. The algorithm first finds a list of start nodes that have no incoming edges and inserts them into a set S. In every DAG, at least one node exists that has no incoming edges. The algorithm then proceeds as follows, using a list L that is initially empty but at the conclusion of the algorithm will contain the sorted nodes:

```
while S is not empty do
  remove a node n from S
  add n to L
  for each node m with an edge e from n to m do
    remove edge e from the DAG
    if m has no other incoming edges, then insert m into S
```

As can be seen, the algorithm, by employing a breadth-first search, not only determines the set of start nodes, which is the first set of nodes for the workflow engine, but also returns an initial execution order for all nodes in the graph. However, because the workflow configuration may define more than one edge that starts at a certain node, the execution order may change based on execution results and may be updated after execution of the first set of nodes, as described below.

In step 230, workflow engine 103 causes execution of the software processing tasks associated with the first set of nodes by the computer system. The execution results in an execution result. If the first set of nodes includes only a single node, workflow engine 103 causes execution of the software processing task associated with that node. The execution result may be the exit code of that software processing task, or any other result generated by the software processing task as described above. If the first set of nodes includes more than one node, the workflow configuration determines whether the software processing tasks associated with these nodes are executed sequentially or in parallel. In particular, the parallel flag for each one of the nodes instructs workflow engine 103 whether the corresponding task may be executed sequentially or in parallel. Illustratively, workflow engine 103 may execute all tasks in parallel whose corresponding nodes have the parallel flag set to true or ‘active’ (the “parallel tasks”). Parallel execution of these parallel tasks leads to reduced runtime for the workflow and therefore faster availability of any results the software application workflow may generate. Workflow engine 103 may cause computing device 102 to execute all parallel tasks at the same time if computing device 102 has enough available resources, such as processor cores and/or available memory. Workflow engine 103 may also cause computing device 102 to execute subsets of the parallel tasks to conserve resources or if not enough resources are available. For example, if workflow engine 103 determines that there are fifteen parallel tasks but only eight processor cores available, workflow engine 103 may first cause execution of eight of the fifteen parallel software programming tasks and, after those tasks are executed, cause execution of the remaining seven parallel tasks. In other embodiments, workflow engine 103 may instruct an operating system of computing device 102 to execute all parallel tasks at the same time and leave resource management to that operating system. It is also expressly contemplated that under certain circumstances workflow engine 103 may ignore the parallel flag and instead cause sequential execution of the parallel tasks. If the first set of nodes includes more than one node, the execution result includes the execution results of all nodes in the first set of nodes.

In step 240, workflow engine 103 determines a second set of nodes of the plurality of nodes to be executed based on the workflow configuration, the plurality of connections, and the execution result. Workflow engine 103 modifies the DAG defined by the workflow configuration based on the execution result. For example, using the configuration 500 described above, and assuming an execution result for node B1005 of success, workflow engine 103 removes the edges from node B1005 to nodes B1003 and B1007. Only the edge from node B1005 to node B1006 remains. Similar to what is described above with reference to step 220, workflow engine 103 then determines the second set of nodes using a breadth-first search and/or Kahn's algorithm on the DAG defined by the workflow configuration. It is also noted that workflow engine 103 may wait for an input before determining the second set of nodes. For example, workflow engine 103 may wait for an input from the user and only continue execution of the workflow once that input has been received. Workflow engine 103 may then additionally determine the second set of nodes based on the received input.

In step 250, workflow engine 103 causes execution in parallel of the software processing tasks associated with the second set of nodes by computing device 102. As is described above with reference to step 230, workflow engine 103 causes parallel execution of all software processing tasks associated with the nodes in the second set of nodes that have their parallel flag set to true. It is also to be noted that, while processing a single software application workflow is described herein, workflow engine 103 may process more than one workflow at the same time. It further expressly contemplated that workflow engine 103 may process a software application workflow in either a stateful or a stateless manner. In a stateful execution, workflow engine 103 may monitor the input and outputs of the various nodes in the workflow and the transition between the nodes. In a stateless execution, workflow engine 103 may simply pass data from one node to the next without further monitoring the data and/or the inputs and outputs of the nodes.

FIG. 3 is a flowchart of an exemplary parallel software application workflow for a use case involving a joint account opening that includes checks with the U.S. Office of Foreign Assets Control (“OFAC”) and checks to ensure compliance with the mandatory Customer Identification Program (“CIP”). As the software application workflow is for a joint account opening, these checks must be performed for each one of the account holders. The workflow includes a plurality of nodes that may be executed in parallel. To this end, the workflow configuration for these nodes includes a parallel flag that is set to true. In the example of FIG. 3, workflow configurations 302 and 304 both include a parallel flat set to true. This means that the tasks associated with these nodes may be executed in parallel by workflow engine 103. Here, the OFAC check, as defined by configuration 302, is executed in parallel for both account holders in tasks 306 and 308. The CIP check, as defined by configuration 304, is executed in parallel for both account holders in tasks 310 and 312. In addition, tasks 306, 308, 310, and 312, even though stemming from two different nodes, are all executed in parallel at the same time.

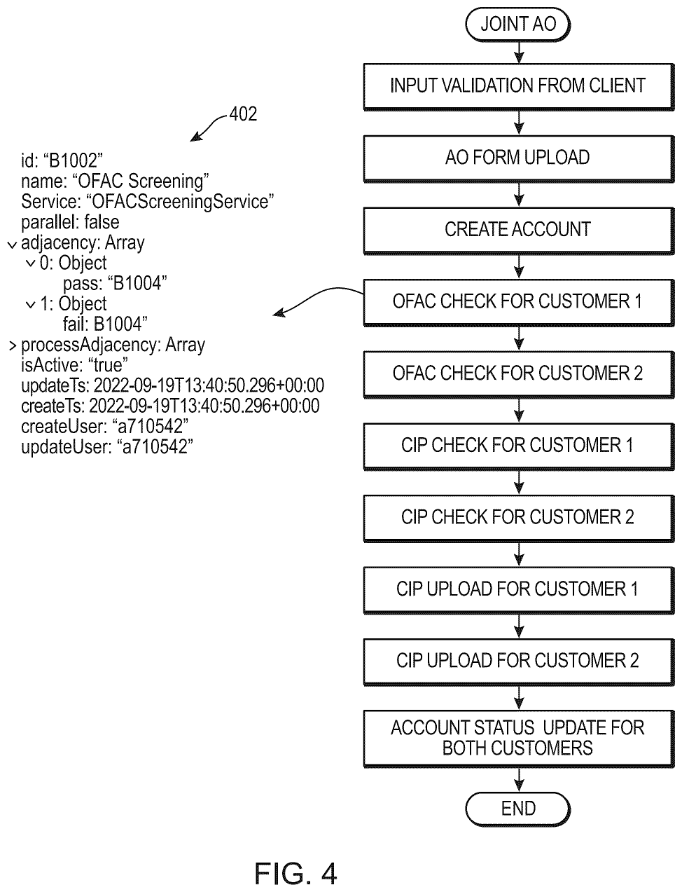

FIG. 4 is a flowchart of an exemplary sequential software application workflow. The workflow shown in FIG. 4 mirrors the joint account opening workflow shown in FIG. 3, with the only difference being that the tasks associated with nodes are executed sequentially. The workflow configuration for each node therefore includes a parallel flag that is set to false, such as in example configuration 402. Thus, workflow engine 103 executes the OFAC and CIP checks for both account holders in a sequential manner: the OFAC check for Customer Two is performed only after the OFAC check for Customer One has completed, the CIP check for Customer One is performed only after the OFAC check for Customer Two has completed, and the CIP check for Customer Two is performed only after the CIP check for Customer One has completed. The workflow shown in FIG. 4, may, for example, be achieved by simply modifying the workflow of FIG. 3 to set all parallel flags to false. As can be appreciated, the workflow engine described herein therefore allows the user to easily switch between sequential and parallel processing as needed.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™M). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™M-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computer-implemented method for processing a software application workflow, the method comprising:
receiving, by a workflow engine of a computing device, a workflow configuration defining the software application workflow including a plurality of nodes and a plurality of connections between the nodes, each of the plurality of nodes being associated with a corresponding software processing task, the workflow configuration further including a parallel flag for each of the plurality of nodes;
determining, by the workflow engine, a first set of nodes of the plurality of nodes to be executed based on the workflow configuration and the plurality of connections;
executing, by the computing device, the software processing tasks associated with the first set of nodes to generate an execution result comprising output from the software processing tasks associated with the first set of nodes;
determining, by the workflow engine, a second set of nodes of the plurality of nodes to be executed based on the workflow configuration, the plurality of connections, and the execution result; and
executing in parallel, by the computing device, the software processing tasks associated with the second set of nodes.

2. The method of claim 1, wherein the workflow engine determines the first set of nodes using Kahn's algorithm.

3. The method of claim 1, wherein the workflow engine determines the second set of nodes using a breadth-first search.

4. The method of claim 3, wherein the breadth-first search identifies one or more nodes adjacent to the first set of nodes using the connections and assigns the adjacent nodes as the second set of nodes.

5. The method of claim 1, wherein determining the second set of nodes results in skipping one or more of the plurality of nodes in the workflow such that the software processing tasks associated with the skipped nodes are not executed by the computing device.

6. The method of claim 1, wherein determining the second set of nodes results in ending the workflow such that no further software processing tasks associated with the workflow are executed by the computing device.

7. The method of claim 1, wherein the computing device executes in parallel only the software processing tasks associated with nodes in the second set of nodes that have a parallel flag set to active.

8. The method of claim 7, wherein the computing device sequentially executes the software processing tasks associated with nodes in the second set of nodes that have a parallel flag set to inactive.

9. The method of claim 1, wherein the workflow configuration comprises a Directed Acrylic Graph (DAG) data structure.

10. A system for processing a software application workflow, the system comprising a computing device having a memory for storing computer-executable instructions and a processor that executes the computer-executable instructions to:
receive, by a workflow engine of the computing device, a workflow configuration defining the software application workflow including a plurality of nodes and a plurality of connections between the nodes, each of the plurality of nodes being associated with a corresponding software processing task, the workflow configuration further including a parallel flag for each of the plurality of nodes;
determine, using the workflow engine, a first set of nodes of the plurality of nodes to be executed based on the workflow configuration and the plurality of connections;
execute the software processing tasks associated with the first set of nodes to generate an execution result comprising output from the software processing tasks associated with the first set of nodes;
determine, using the workflow engine, a second set of nodes of the plurality of nodes to be executed based on the workflow configuration, the plurality of connections, and the execution result; and
execute in parallel the software processing tasks associated with the second set of nodes.

11. The system of claim 10, wherein the workflow engine determines the first set of nodes using Kahn's algorithm.

12. The system of claim 10, wherein the workflow engine determines the second set of nodes using a breadth-first search.

13. The system of claim 12, wherein the breadth-first search identifies one or more nodes adjacent to the first set of nodes using the connections and assigns the adjacent nodes as the second set of nodes.

14. The system of claim 10, wherein determining the second set of nodes results in skipping one or more of the plurality of nodes in the workflow such that the software processing tasks associated with the skipped nodes are not executed by the computing device.

15. The system of claim 10, wherein determining the second set of nodes results in ending the workflow such that no further software processing tasks associated with the workflow are executed by the computing device.

16. The system of claim 10, wherein the computing device executes in parallel only the software processing tasks associated with nodes in the second set of nodes that have a parallel flag set to active.

17. The system of claim 16, wherein the computing device sequentially executes the software processing tasks associated with nodes in the second set of nodes that have a parallel flag set to inactive.

18. The system of claim 10, wherein the workflow configuration comprises a Directed Acrylic Graph (DAG) data structure.
